(19) United States
(12) Patent Application Publication
(10) Pub. No.: US 2010/0055767 A1
(43) Pub. Date: Mar. 4, 2010

(54) BIO-ENERGY SYSTEM AND APPARATUS

(76) Inventor: Pearse O'Kane, Dublin (IE)

Correspondence Address: HOLLAND & KNIGHT LLP, 10 ST. JAMES AVENUE, BOSTON, MA, 02116-3889, US

(21) Appl. No.: 11/720,773

(22) PCT Filed: Nov. 2, 2005
(86) PCT No.: PCT/IE05/00123

§ 371 Date: Nov. 18, 2009

(30) Foreign Application Priority Data
Dec. 2, 2004 (IE) S2004/0808

(51) Int. Cl. A62D 3/02; A62B 29/00

(52) U.S. Cl. 435/262.5; 435/283.1

(57) ABSTRACT

A bio-energy system includes a waste collecting station at which raw waste material such as municipal waste, household waste and the like is collected. The waste is delivered through a rotating organic material digester in a controlled manner for converting the organic waste material content of the raw waste to a bio-fuel. Treated material discharged from the digester is passed through a screen to remove any inorganic materials, leaving the bio-fuel. The bio-fuel is dried at a drying station and then delivered to a boiler for combustion to generate energy.

### BACKGROUND OF THE INVENTION

This invention relates to bio-energy systems and apparatus.

In U.S. Pat. No. 5,047,349 and U.S. Pat. No. 5,407,809 for example there are described systems and apparatus for converting organic waste material such as municipal waste into compost. The system shown in U.S. Pat. No. 5,047,349 operates in a batch treatment system, whilst the system of U.S. Pat. No. 5,407,809 is a continuous feed process. The content of these documents is included herein by reference. Each of these systems include a digester of the type comprising a cylindrical drum having an organic material inlet at one end and a treated material outlet at its other end, said cylindrical drum being rotatably mounted on a support for rotation about a central axis of the drum, means for rotating the drum on the support, the rotational axis of the drum being inclined downwardly between the inlet and the outlet of the drum to feed material between the inlet and the outlet, a plurality of spaced-apart baffles mounted within the drum between the inlet and the outlet to control the flow of material through the drum between the inlet and the outlet, each baffle having an opening for through passage of material. Within the digester drum the baffles are typically welded to an inside face of the drum side-wall. During processing of the material in the drum a relatively corrosive environment is generated within the drum. In such a corrosive environment the welds can fail, leading to detachment of the baffles from the wall of the drum. In extreme cases the drum side-wall will crack.

The compost generated using such digesters can be used for agricultural and horticultural purposes. At present the volume of municipal waste treated in this way is relatively small. The bulk of municipal waste is currently disposed of in landfill sites. This is undesirable from an environmental point of view. However, if the organic material in increasing amounts of municipal waste is converted to compost as described above for example, in certain markets the volume of the compost produced would greatly exceed the demand for agriculture and horticulture. While it could be disposed of in landfill sites this is not an ideal solution to the problem.

The present invention is directed towards overcoming these problems.

### SUMMARY OF THE INVENTION

According to the invention there is provided a bio-energy system, including:
collecting raw waste material which includes organic waste material,
feeding said raw waste material through an organic material digester in a controlled manner between an inlet and an outlet of the digester and treating the raw waste material with aerobic bacteria in the digester for converting the organic waste material content of the raw waste material to a bio-fuel,
discharging treated material from the outlet of the digester,
separating said bio-fuel from inorganic materials in the treated material,
   The system may further include utilising the bio-fuel produced for generating energy.

The bio-fuel produced can be used in any suitable way for generating energy and as an alternative to fossil fuels.

In one embodiment of the invention the system includes at least partially drying the bio-fuel material for reducing the moisture content of the bio-fuel material prior to utilisation of the bio-fuel for energy generation.

The bio-fuel may be dried in any suitable fashion. For example the bio-fuel material may be compressed for reducing its moisture content. Alternatively or in addition the moisture content could be reduced using any other form of drying system, including for example thermal dryers, fluidised bed dryers, air dryers and bio drying.

In another embodiment the system includes screening the treated material for separating the bio-fuel and inorganic materials (that is biodegradable and non-biodegradable materials).

In a further embodiment the system includes sorting the inorganic (non-biodegradable) material into recyclable waste material and non-recyclable waste material.

In a preferred embodiment the digester includes a cylindrical drum having the raw material inlet at one end and a treated material outlet at the other end, said drum having at least one internal compartment for treatment of the waste material, said cylindrical drum being rotatably mounted on a support for rotation about a central axis of the drum, and means for rotating the drum about said central axis of the drum. Preferably the rotational axis of the drum is inclined downwardly between the inlet and the outlet of the drum. However in some cases the drum rotational axis may be substantially horizontal.

In another embodiment the digester includes a rotatable cylindrical drum, at least one baffle plate mounted within the drum to control the flow of material through the drum between an inlet and an outlet of the drum, the or each baffle plate being secured to the drum by attachment means which extends outwardly from the baffle plate through a cylindrical side-wall of the drum.

In another embodiment the attachment means is secured to an exterior of the drum.

In one embodiment of the invention the drum has a support ring extending around an interior or an exterior of the drum in alignment with each baffle plate within the drum.

In another embodiment the attachment means is secured to the support ring.

In a further embodiment the attachment means includes a plurality of spaced-apart rods, each rod having an inner end and an outer end, said inner end being secured to the baffle plate and said outer end being secured to the drum.

In a preferred embodiment the inner end of each rod is secured at an outer circumferential edge of the baffle plate spaced inwardly from a front face and from a rear face of the baffle plate. In another embodiment the inner end of the rod locates in a complementary radial slot at an edge of the baffle plate.

In another embodiment the rods extend radially outwardly from the baffle plate through the drum side-wall.

In another embodiment an outer end of each rod engages in a complementary radial mounting hole in the support ring.

In a further embodiment at least the region where an outer edge of the baffle plate meets the drum side-wall is coated with a corrosion resistant material.

In a preferred embodiment each face of a baffle plate is coated with said corrosion resistant material.

In another embodiment the baffle plate and associated rod connectors are of stainless steel material.

Preferably the corrosion resistant material is an epoxy resin.

In another embodiment one or both faces of each baffle plate is protected by a sacrificial material.

Preferably the sacrificial material is made of hardwood, plastic or other shock and corrosion resistant material.

In another embodiment the inner end and the outer end of each rod are secured by welds.

In a further embodiment each baffle plate has an opening for through passage of material which is located off-centre in the baffle plate.

Conveniently said opening has an elliptical shape. The opening may be arranged such that either a minor axis or a major axis of the elliptical opening lies along a radius of the baffle plate.

In another embodiment the cylindrical drum has a raw material inlet at one end and a treated material outlet at its other end, said cylindrical drum being rotatably mounted on a support for rotation about a central axis of the drum, means for rotating the drum on the support, the rotational axis of the drum being inclined downwardly between the inlet and the outlet of the drum to feed material between the inlet and the outlet, a plurality of spaced-apart baffles mounted within the drum between the inlet and the outlet to control the flow of material through the drum between the inlet and the outlet, each baffle having an opening for through passage of material. If desired a door may be provided at each opening in the baffles.

In another embodiment the means for rotating the drum on the support includes a ring gear which extends around a circumference of the drum, a complementary pinion driveably engaged with the ring gear, and a drive motor connected through a reduction gearbox with the pinion.

In a further embodiment the means for rotating the drum on the support comprises a tire which extends around a circumference of the drum and is fixed thereto, said tire resting on and supported by a pair of spaced-apart wheels which are rotatably mounted on a support frame, at least one of said wheels being a friction drive wheel connected to an associated drive motor operable to rotate the friction drive wheel on the support frame for rotation of the drum.

In another embodiment the drive motor is a hydraulic motor.

In a further embodiment two tyres are mounted spaced-apart on the drum, each of said tyres having associated drive means for rotation of the tyre and hence the drum.

In a particularly preferred embodiment the cylindrical drum is protected internally by longitudinal stress bars fixed to an inside face of the drum and extending along the length of the drum, each of said stress bars projecting inwardly from the inside face of the drum. Ideally the stress bars are approximately four to five inches (100 mm-125 mm) high, about one inch (25 mm) thick and spaced about four to five inches (100 mm-125 mm) apart. Channels formed between these stress bars fill with organic material when the drum is in use and greatly enhance the impact absorption as well as provide the biological medium required to accelerate the fermentation process of the organic material.

### BRIEF DESCRIPTION OF THE DRAWINGS

The invention will be more clearly understood by the following description of some embodiments thereof, given by way of example only, with reference to the accompanying drawings, in which;

FIG. 1 is a schematic illustration of a bio-energy system according to the invention;

FIG. 2 is another schematic illustration of the bio-energy system,

FIG. 3 is a perspective view of a digester according to the invention;

FIG. 4 is a schematic cross sectional illustration of the digester;

FIG. 5 is an elevational view of another digester according to the invention;

FIG. 6 is a view similar to FIG. 5 of the digester of FIG. 5;

FIG. 7 is an end elevational view taken along the line VII-VII of FIG. 6;

FIG. 8 is an end elevational view taken along the line VIII-VIII of FIG. 6;

FIG. 9 is a sectional elevational view taken along the line IX-IX of FIG. 6;

FIG. 10 is a sectional elevational view taken along the line X-X of FIG. 6;

FIG. 11 is a detail sectional view showing portion of a cylindrical drum of the digester; and

FIG. 12 is a detail sectional view showing portion of a drum wall of the digester.

### DETAILED DESCRIPTION OF PREFERRED EMBODIMENTS

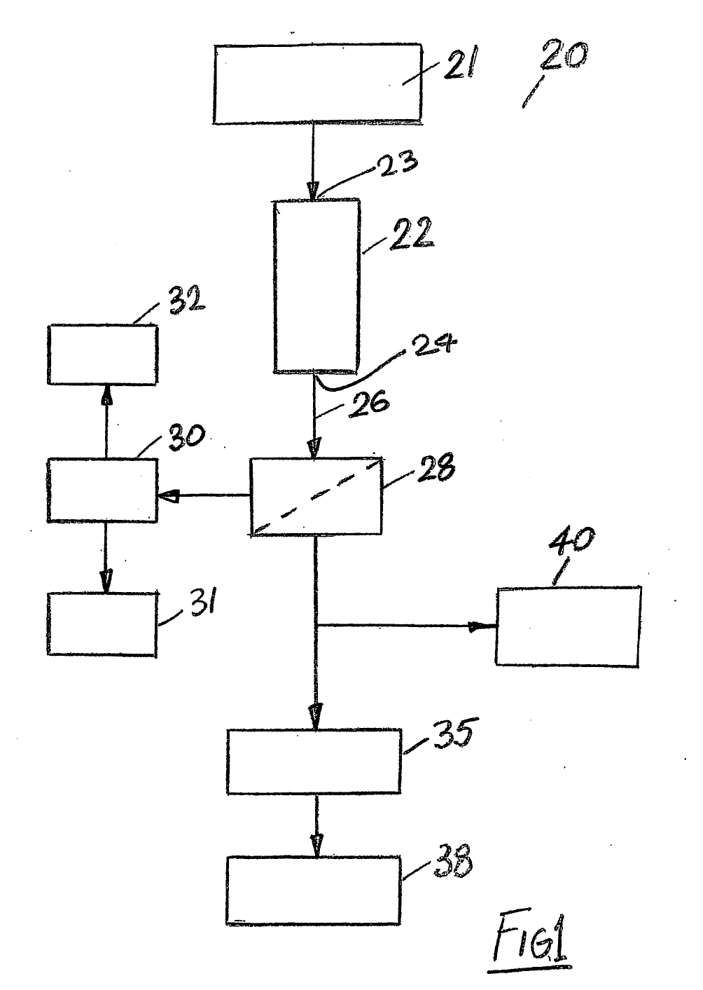

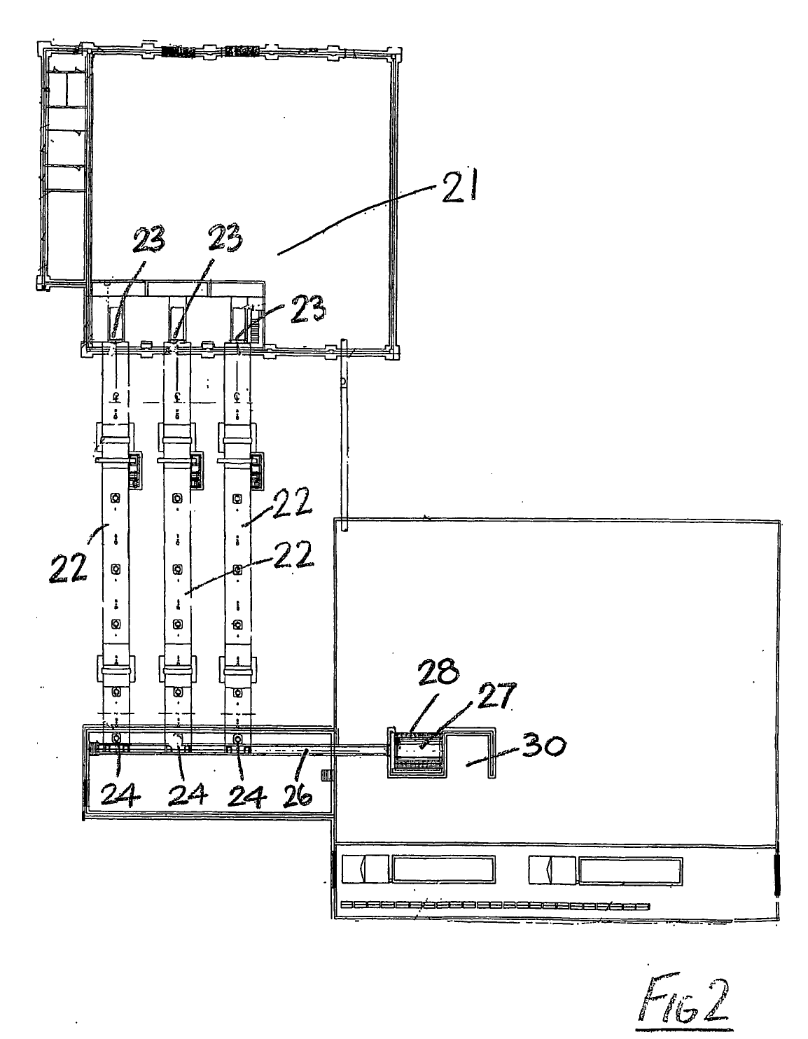

Referring to the drawings, and initially to FIGS. 1 and 2 thereof, there is illustrated a bio-energy system according to the invention indicated generally by the reference numeral 20. The system 20 includes a waste collecting station 21 at which raw waste material such as municipal waste, household waste and the like is collected. This raw waste material is then fed to an inlet of a rotary organic material digester 22. The raw waste material is delivered through the rotary digester 22 in a controlled manner between an inlet 23 and an outlet 24 of the digester 22 for converting the organic waste material content of the raw waste material to a bio-fuel.

The rotary organic material digester 22 includes a cylindrical drum having a raw material inlet 23 at one end and a treated material outlet 24 at the other end. The cylindrical drum is rotatably mounted on a support for rotation about a central axis of the drum. The rotational axis of the drum is inclined downwardly between the inlet 23 and the outlet 24 of the drum to gradually feed material between the inlet 23 and the outlet 24 of the drum as the drum is rotated. Suitable types of digester are described more fully later. Alternatively digesters of the type described in U.S. Pat. No. 5,047,349 or U.S. Pat. No. 5,407,809 could be used.

FIG. 2 shows three of the digesters 22 arranged in parallel for treating the waste material. Treated material is discharged from an outlet 24 of each digester 22 onto a conveyor 26 which delivers the treated material to a hopper 27 feeding a screen 28. The screen 28 separates the bio-fuel from the inorganic (non-biodegradable) materials in the treated material. The sanitised inorganic material is delivered to a residual collection bay 30 and is subsequently sorted into recyclable material 31 and non-recyclable material 32, which is delivered to a landfill for disposal.

The bio-fuel material is delivered from the screen 28 to a drying station 35 in which the moisture content of the bio-fuel material is reduced by compression of the bio-fuel material and/or any other suitable drying method. The dried bio-fuel material can then be used as a bio-fuel in a generating boiler 38 for example, or as any fossil fuel alternative.

If desired, a portion of organic material may be diverted downstream of the screen to a compost bay 40 for subsequent curing and use as agricultural or horticultural compost.

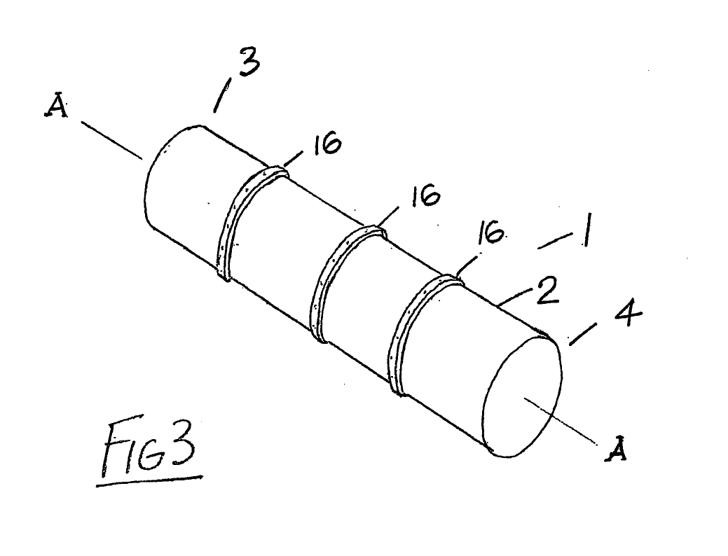

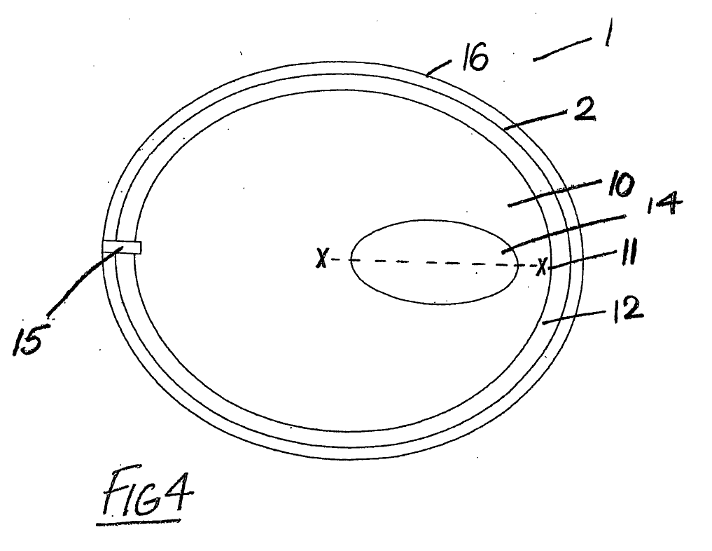

Referring now to FIGS. 3 and 4 of the drawings there is illustrated a digester according to the invention indicated generally by the reference numeral 1. The digester 1 has a cylindrical drum 2 which is rotatably mounted for rotation about a central longitudinal axis A of the drum 2. Drive means (not shown) is provided for rotating the drum 2 about said longitudinal axis A in an inclined position to deliver material between an inlet end 3 and an outlet end 4 of the drum for treatment as it passes through the drum 2.

A plurality of baffle plates 10 are mounted spaced-apart within the drum 2 between the inlet 3 and the outlet 4 of the drum 2 separate the drum interior into a number of treatment compartments and to control the flow of material through the drum 2 between the inlet 3 and the outlet 4. Each baffle plate 10 is circular and is a close fit within the drum 2, an outer circumferential edge 11 of the baffle plate 10 abutting an inner face of a cylindrical side wall 12 of the drum 2. The baffle plate 10 is formed of stainless steel material and has a protective epoxy resin coating. Additional impact protection may also be provided as described later.

Each baffle plate 10 is mounted within the drum 2 substantially perpendicular to the longitudinal axis A of the drum 2. The baffle plates 10 subdivide the drum 2 into a number of treatment compartments arranged in series between the inlet 3 and outlet 4 of the drum 2. An aperture or port 14 in each baffle plate 10 allows controlled through passage of material from one compartment to the next as the material travels between the inlet 3 and outlet 4 of the drum 2. The aperture or port 14 is open, or if required fitted with a door (not shown) which ensures complete segregation in the area or compartment between the baffles 10. In the embodiment shown in FIG. 4 the port 14 is generally elliptical in shape. The port 14 is located off-centre in the baffle plate 10 with a major axis X of the port 14 generally lying along a radius of the baffle plate 10.

Each baffle plate 10 is secured within the drum 2 by means of a plurality of circumferentially spaced-apart stainless steel rods 15, only one of which is illustrated in FIG. 4. Each rod 15 extends radially outwardly from the baffle plate 10 through an opening in the drum side-wall 12, engaging a stainless steel outer support ring 16 which extends around the drum 2 in alignment with the associated baffle plate 10. A plurality of spaced-apart radial holes are provided in the ring 16 for reception of the rods 15 which are welded to the ring 16 after welding to the baffle plate 10. The support ring 16 is a close fit about the drum 2 and is welded to an exterior of the drum 2. In an alternative arrangement the support ring 16 may be mounted inside the drum 2 instead of outside as shown.

A surface of each baffle plate 10 and the region where an outer edge of each baffle plate 10 engages the side-wall 12 of the drum 2 is coated with an epoxy coating. A suitable coating is the two component, solvent based epoxy coating FX-470 supplied by Fox Industries.

In use, the digester 1 is slowly rotated. Raw waste material is delivered to the inlet 3 of the digester 1 and travels through the digester 1 between the inlet 3 and the outlet 4. Within the digester 1 aerobic bacteria converts the organic waste material content of the raw waste material into a bio-fuel. Treated material is discharged from the outlet 4 of the drum 2. The treated material will include organic/biodegradable material and inorganic/non-biodegradable material. This can be separated as previously described.

It will be noted that with the baffle mounting arrangement of the invention all welded joints are protected against any corrosive environment within the digester drum 2. Further, the support ring 16 gives added reinforcement to the drum 2 at each baffle mounting location.

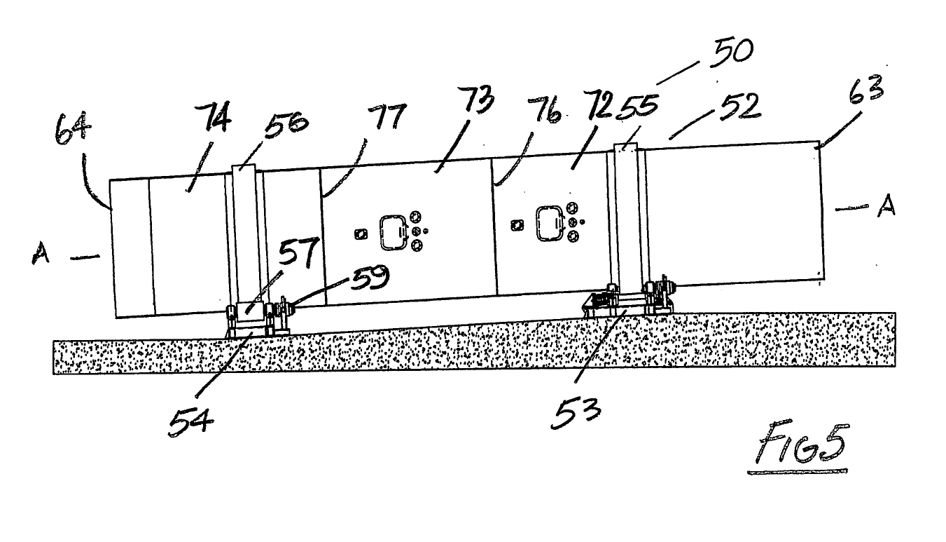

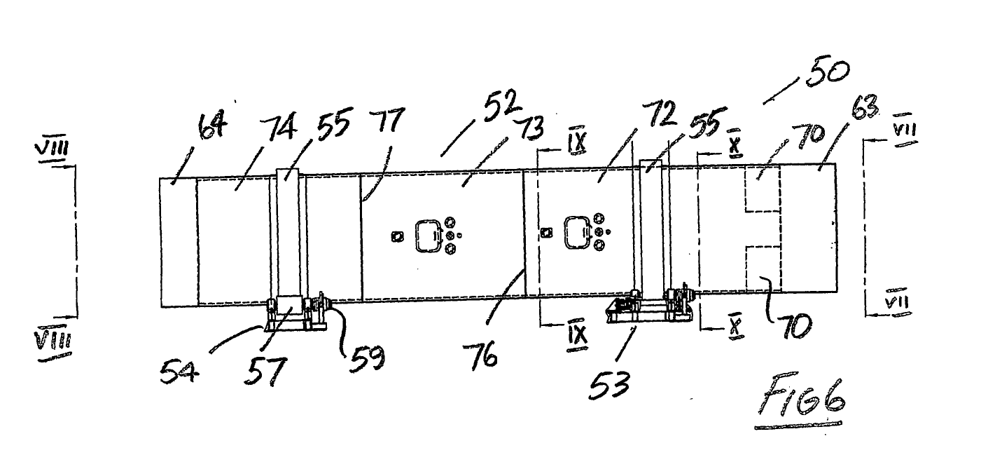

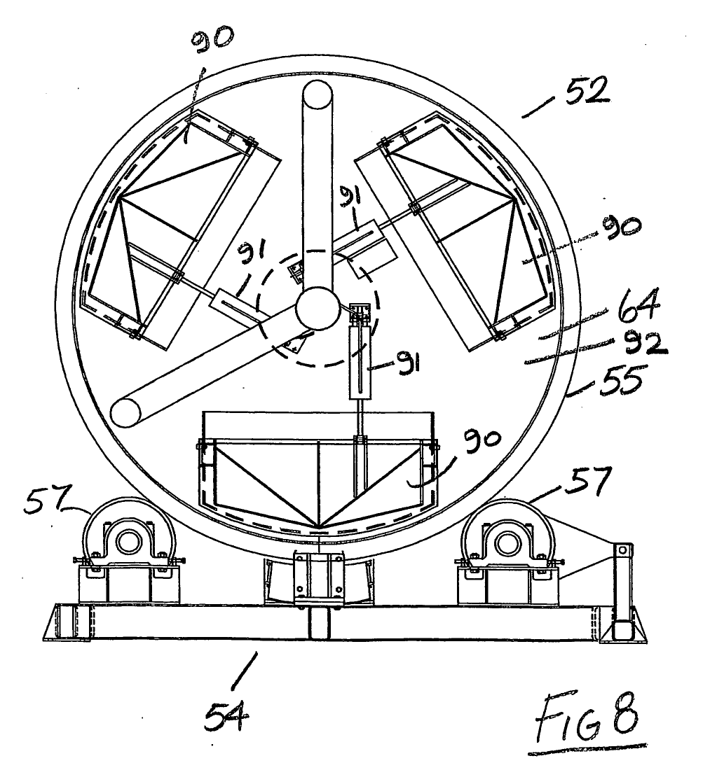

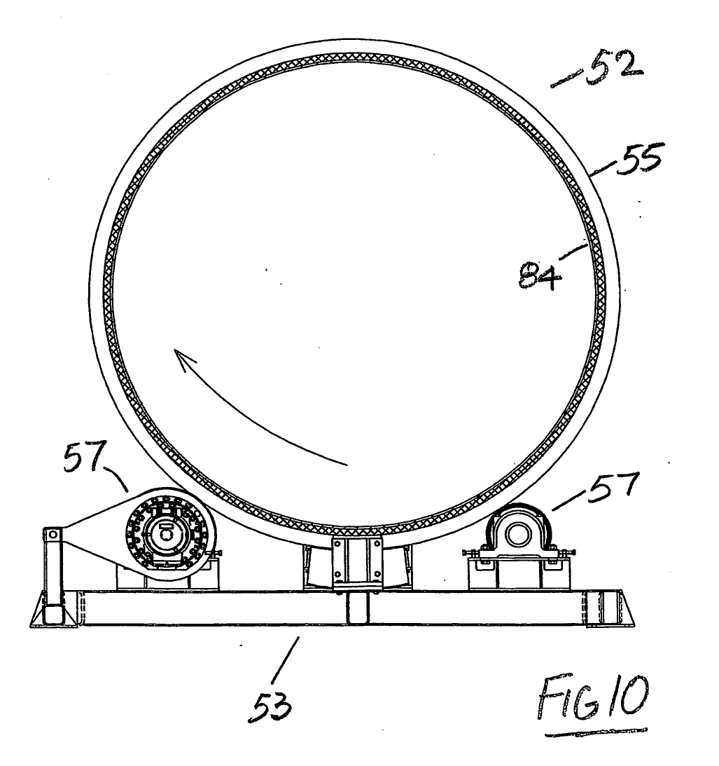

Referring to FIGS. 5 to 12 there is shown another digester according to the invention indicated generally by the reference numeral 50. The digester 50 comprises a cylindrical drum 52 which is rotatably mounted on a pair of spaced-apart support frames, namely a front support frame 53 and a rear support frame 54. Two spaced-apart metal tires 55 extend around a circumference of the drum 52. Each tire 55, 56 is supported by a pair of spaced-apart wheels 57 (best seen in FIGS. 8 and 10) which are rotatably mounted on the support frames 53, 54. At least one of the wheels 57 comprises a friction drive wheel which is connected to an associated drive motor 59 to rotate the friction drive wheel 57 on the support frame 53, 54 for rotation of the drum 52 on the support frames 53, 54. Preferably friction drive wheels 57 are provided at each support frame 53, 54. The drive motors 59 may conveniently be either hydraulic motors or electric motors. Any other arrangement for driving the friction drive wheels 57 may be provided as an alternative.

It will be noted that a central longitudinal axis A of the drum 52 about which the drum 52 rotates is inclined at an angle of about 2.5° to the horizontal. Thus the drum 52 is inclined downwardly between an inlet end 63 and outlet end 64 of the drum 52. This provides for gravity feed of material through the drum 52 between the inlet end 63 and outlet end 64 as the drum 52 is rotated.

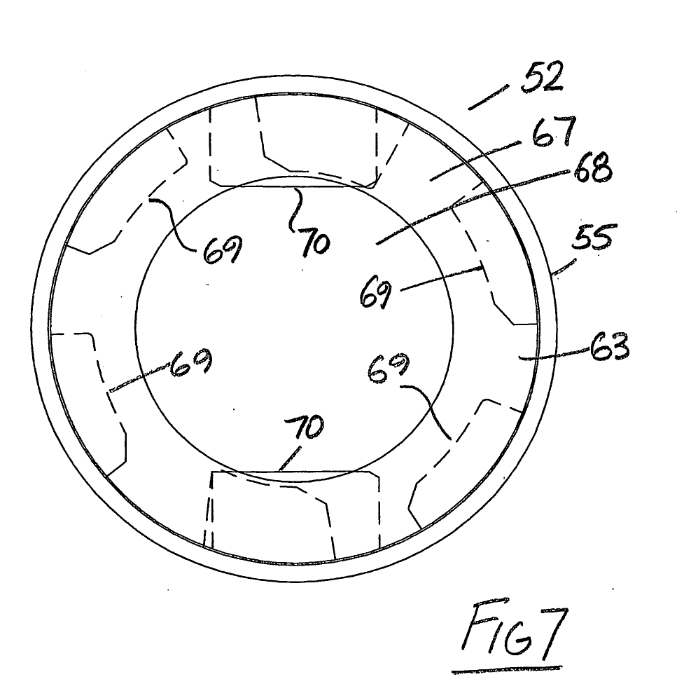

The inlet end 63 of the drum 52 can be seen in more detail in FIG. 7. An annular end plate 67 has a central circular inlet opening 68. A number of scoop plates 69 mounted on an inside face of the drum wall project inwardly from the drum wall. The scoop plates 69 feed waste material into transfer boxes 70 for delivery to an interior of the drum 52.

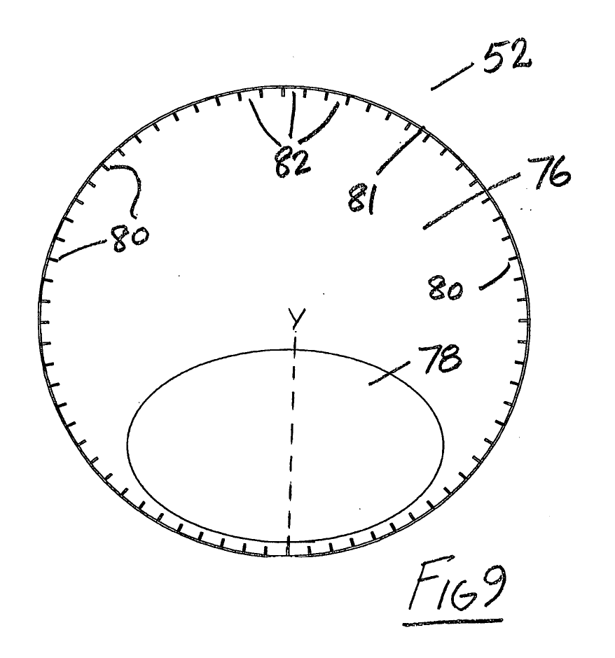

Referring to FIGS. 5 and 9, an interior of the drum 52 is divided into three compartments namely a first compartment 72 a second compartment 73 and a third compartment 74 by a pair of spaced-apart baffle plates 76, 77. As previously described these baffle plates 76, 77 control the flow of material through the drum 52 between the inlet 63 and outlet 64.

Each baffle plate 76, 77 is mounted within the drum 52 substantially perpendicular to the longitudinal axis A of the drum 52. The mounting is preferably as described previously for the baffle plate shown in. FIG. 4. A port 78 in each baffle plate 76, 77 allows through passage of material between adjacent compartments 72, 73, 74 separated by the baffle plate 76, 77. In this case the port 78 has an elliptical shape with a minor axis Y of the ellipse substantially coincident with a radius of the baffle plate 76, 77 or drum 52. As can be seen in FIG. 9 the port 78 is located offset from a centre of the drum 52.

Referring to FIG. 9 the drum 52 is protected internally by a plurality of spaced-apart longitudinal stress bars 80 which project radically inwardly from an inside face 81 of the drum 52. The stress bars 80 are fixed to the inside face 81 and extend along the length of the drum 52. The stress bars 80 are approximately four to five inches (100 mm-125 mm) high, about one inch (25 mm) thick and about four to five inches (100 mm-125 mm) apart. Channels 82 formed between these stress bars 80 fill with organic material when the drum 52 in use and greatly enhance the impact absorption as well as provide biological medium required to accelerate the fermentation process of the organic material.

Preferably each baffle plate 76, 77 is made from stainless steel or some other anti-corrosion material. In addition, each face of the baffle plate 76, 77 may be protected by a sacrificial material such as hardwood, plastic or other shock and corrosion resistant material. This prevents damage to the baffle plate 76, 77 during operation of the drum 52.

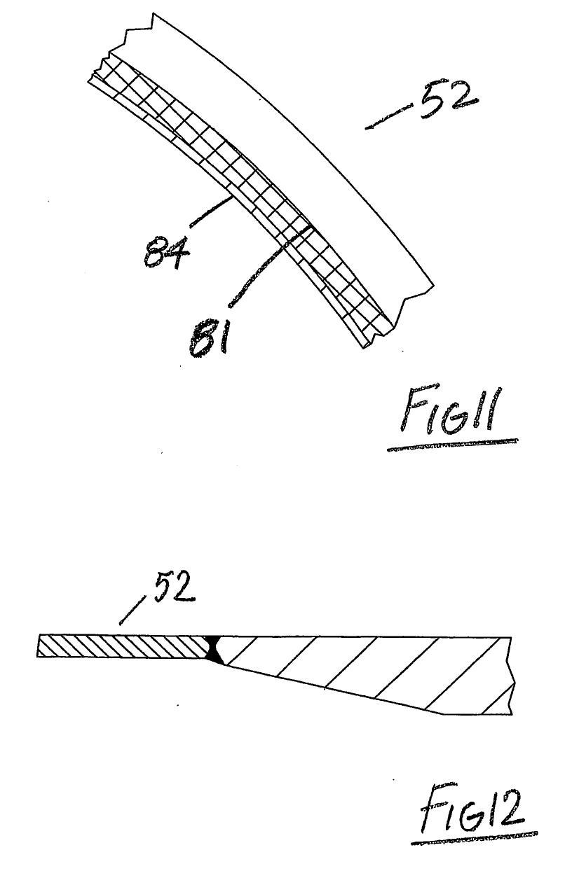

The inside face 81 of the drum 52 is coated with a 50 mm layer 84 of polyurethane to protect the drum side wall, as shown in FIGS. 10 and 11.

Referring to FIG. 8 the outlet end 64 of the drum 52 is shown. A number of discharge doors 90 operated by rams 91 are mounted on an end plate 92 of the drum 52. The doors 90 can be opened and closed by the rams 91 for controlling discharge of treated material from the drum 52.

FIG. 12 shows reinforcement of the drum side wall at the tire mounting locations.

It will be appreciated that the invention provides a system and apparatus for manufacturing a bio-fuel which can be used as an alternative to fossil fuels.

It will be appreciated that the digester may have one or more compartments for the treatment of the waste material. Where a number of compartments are provided these may be provided as described by sub-dividing the drum into a number of compartments or indeed a number of drums, each comprising one compartment, may be arranged in series with material being passed from one drum to the next.

The invention is not limited to the embodiments hereinbefore described which may be varied in both construction and detail within the scope of the appended claims.

1-58. (canceled)

59. A bio-energy system including:
collecting raw waste material which includes organic waste material,
feeding said raw waste material through an organic material digester in a controlled manner between an inlet and an outlet of the digester and treating the raw waste material with aerobic bacteria in the digester for converting the organic waste material content of the raw waste material to a bio-fuel,
discharging treated material from the outlet of the digester,
separating said bio-fuel from inorganic materials in the treated material, and
utilising the bio-fuel produced for generating energy.

60. A system as claimed in claim 59 including at least partially drying the bio-fuel material for reducing the moisture content of the bio-fuel material prior to utilising the bio-fuel for generating energy.

61. A system as claimed in claim 60 including compressing the bio-fuel material for reducing the moisture content of the bio-fuel material.

62. A system as claimed in claim 59 including screening the treated material for separating the bio-fuel and inorganic materials.

63. A system as claimed in claim 59 including sorting the inorganic material into recyclable waste material and non-recyclable waste material.

64. A system as claimed in claim 59 wherein the digester includes a cylindrical drum having the raw material inlet at one end and a treated material outlet at the other end, said drum having at least one internal compartment for treatment of the waste material, said cylindrical drum being rotatably mounted on a support for rotation about a central axis of the drum, and means for rotating the drum about said central axis of the drum.

65. A system as claimed in claim 64 wherein at least one baffle plate is mounted within the drum to divide the interior of the drum into two or more treatment compartments and to control the flow of material through the drum between the inlet and the outlet of the drum, the or each baffle plate being secured to the drum by attachment means which extends outwardly from the baffle plate through a cylindrical side wall of the drum.

66. A system as claimed in claim 65 wherein the attachment means is secured to an exterior of the drum.

67. A system as claimed in claim 64 wherein the drum has a support ring extending around the drum in alignment with each baffle plate within the drum.

68. A system as claimed in claim 67 wherein the support ring extends around an exterior of the drum.

69. A system as claimed in claim 67 wherein the support ring extends around an interior face of the drum sidewall.

70. A system as claimed in claim 67 wherein the attachment means is secured to the support ring.

71. A system as claimed in claim 65 wherein the attachment means includes a plurality of spaced-apart rods, each rod having an inner end and an outer end, said inner end being secured to the baffle plate and said outer end being secured to the drum.

72. A system as claimed in claim 71 wherein the inner end of each rod is secured at an outer circumferential edge of the baffle plate spaced inwardly from a front face and from a rear face of the baffle plate.

73. A system as claimed in claim 71 wherein the inner end of the rod locates in a complementary radial slot at an outer edge of the baffle plate.

74. A system as claimed in claim 71 wherein the rods extend radially outwardly from the baffle plate through the drum side wall.

75. A system as claimed in claim 74 wherein an outer end of each rod engages in a complementary radial mounting hole in the support ring.

76. A system as claimed in claim 65 wherein at least an upstream face of each baffle plate is protected by a sacrificial material.

77. A system as claimed in claim 65 wherein a plurality of spaced-apart baffles are mounted within the drum between the inlet and the outlet to control the flow of the material through the drum between the inlet and the outlet, each baffle having an opening for through passage of material.

78. A system as claimed in claim 65 wherein each baffle plate has an opening for a through passage of material which is located off-centre in the baffle plate.

79. A system as claimed in claim 78 wherein said opening has an elliptical shape.

80. A system as claimed in claim 79 wherein either a minor axis or a major axis of the elliptical opening lies along a radius of the baffle plate.
